(19) United States
(12) Patent Application Publication
(10) Pub. No.: US 2016/0110234 A1
(43) Pub. Date: Apr. 21, 2016

(54) APPARATUS AND METHOD FOR PROCESSING COMPLEX EVENT BASED ON HIGH LOAD PATH

(71) Applicant: Korea Institute of Science and Technology Information, Daejeon (KR)

(72) Inventors: Chang Hoo Jeong, Daejeon (KR); Jung Ho Um, Jeollabuk-do (KR); Taehong Kim, Daejeon (KR); Seungwoo Lee, Daejeon (KR); Hanmin Jung, Daejeon (KR); Won Kyung Sung, Daejeon (KR)

(21) Appl. No.: 14/571,997

(22) Filed: Dec. 16, 2014

(30) Foreign Application Priority Data
Oct. 17, 2014 (KR) 10-2014-0140576

(51) Int. Cl. G06F 9/54

(52) U.S. Cl. CPC G06F 9/542; G06F 9/546

(57) ABSTRACT

An apparatus and method for processing a complex event based on a high load path includes a high load path search unit configured to identify a high load path by analyzing the log pattern of a message transfer path and a partition generation unit configured to generate a partition based on the identified high load path.

### CROSS REFERENCE TO RELATED APPLICATION

The present application claims the benefit of Korean Patent Application No. 10-2014-0140576 filed in the Korean Intellectual Property Office on Oct. 17, 2014, the entire contents of which are incorporated herein by reference.

### BACKGROUND OF THE INVENTION

1. Technical Field

The present invention relates to an apparatus and method for processing a complex event based on a high load path and, more particularly, to an apparatus and method for processing a complex event based on a high load path, wherein a high load path is identified by analyzing the log pattern of a message transfer path and a partition is generated based on the identified high load path.

2. Description of the Related Art

As the Internet is advanced, numerous data is generated and distributed by netizens every day. Recently, in many companies, in particular, in many search engine companies and web portals, to collect and accumulate huge amounts of data as much as possible and to extract meaningful data from the collected data as soon as possible become a company's competitiveness.

For this reason, many companies construct large-scale clusters at a low cost and are doing a lot of research into high-capacity distributed management and task distribution parallel processing technologies.

The processing of a complex event based on a state transition diagram is performed based on data collected from several independent events. In this case, locality in which a work load is unequally distributed may occur because the processing frequency of each node and edge on the state transition diagram may be different.

A hash partitioning scheme for performing partitioning based on the ID of a node is used as a partitioning scheme for distributing a work load.

In such a hash partitioning scheme, however, a distribution and parallelism in processing complex events are not effectively performed because the influence of each node on a work load is never taken into consideration due to partitioning based on a node ID and a change in a work load attributable to a change in time in processing complex events is not flexibly handled.

### PRIOR ART DOCUMENT

### Patent Document

A prior art 1: Korean Patent No. 1076762 entitled “Apparatus for Assigning Process and Method for Operating the Same”

### SUMMARY OF THE INVENTION

Accordingly, the present invention has been made keeping in mind the above problems occurring in the prior art, and an object of the present invention is to provide an apparatus and method for processing a complex event based on a high load path, which is capable of effectively distributing a work load based on a high load path.

Another object of the present invention is to provide an apparatus and method for processing a complex event based on a high load path, which is capable of identifying a high load path based on an accumulated log pattern and dynamically updating a partitioning criterion using the identified high load path.

In accordance with an aspect of the present invention, there is provided an apparatus for processing a complex event based on a high load path, including a high load path search unit configured to identify a high load path by analyzing the log pattern of a message transfer path and a partition generation unit configured to generate a partition based on the identified high load path.

The apparatus for processing a complex event based on a high load path may further include a log record unit configured to record the log of the message transfer path. The log record unit may differently set a work load depending on the work repetition number of message transfer paths or the amount of network communication.

The high load path search unit may identify a message transfer path that is repeated by a predetermined specific number or more or that requires the execution time of a predetermined specific time or more as the high load path by analyzing the log pattern.

In the case of a high load path, the partition generation unit may divide the high load path by the number of workers and generate a partition. In the case of a message transfer path other than a high load path, the partition generation unit may calculate the number of edges and allocate the edges to the most connected partition.

The apparatus for processing a complex event based on a high load path may further include a complex event processing unit configured to process a complex event based on the partition generated by the partition generation unit.

In accordance with another aspect of the present invention, there is provided a method for processing, by a complex event processing apparatus, including identifying a high load path by analyzing the log pattern of a message transfer path and generating a partition based on the identified high load path.

The method for processing a complex event based on a high load path may further include recording the log of a message transfer path before identifying the high load path by analyzing the log pattern of the message transfer path.

The high load path may include a message transfer path that is repeated by a predetermined specific number or more or that requires the execution time of a predetermined specific time or more.

Generating the partition may include dividing the high load path by the number of workers and generating a partition in the case of a high load path, and calculating the number of edges and allocating the edges to the most connected partition in the case of a message transfer path other than a high load path.

The method for processing a complex event based on a high load path may further include processing a complex event based on the generated partition after generating the partition.

In accordance with yet another aspect of the present invention, there is provided a computer-readable recording medium on which a program for executing a method for processing a complex event based on a high load path has been recorded, wherein the method includes identifying a high load path by analyzing the log pattern of a message transfer path when the program is executed by the complex event processing apparatus and generating a partition based on the identified high load path.

### BRIEF DESCRIPTION OF THE DRAWINGS

FIG. 1 is a diagram schematically illustrating an apparatus for processing a complex event based on a high load path in accordance with an embodiment of the present invention;

FIG. 2 is a diagram illustrating a method for processing, by the complex event processing apparatus, a complex event in accordance with an embodiment of the present invention; and

FIG. 3 is an exemplary diagram of screens for illustrating a method for generating a partition in accordance with an embodiment of the present invention.

### DESCRIPTION OF REFERENCE NUMERALS

100: complex event processing apparatus
110: log record unit
120: high load path search unit
130: partition generation unit
140: complex event processing unit

### DETAILED DESCRIPTION

Hereinafter, an apparatus and method for processing a complex event based on a high load path in accordance with embodiments of the present invention are described in detail below with reference to the accompanying drawings. The embodiments to be described are provided in order for those skilled in the art to easily understand the technical spirit of the present invention, and the present invention is not limited to the embodiments. Furthermore, matters represented in the accompanying drawings have been diagrammed in order to easily describe the embodiments of the present invention, and the matters may be different from forms that are actually implemented.

Each of elements to be described herein is only an example for implementing the embodiments of the present invention. Accordingly, in other implementations of the present invention, different elements may be used without departing from the spirit and scope of the present invention. Furthermore, each element may be purely formed of a hardware or software element, but may also be implemented using a combination of various hardware and software elements that perform the same function.

Furthermore, an expression that some elements are “included” is an expression of an “open type”, and the expression simply denotes that the corresponding elements are present, but it should not be understood that additional elements are excluded.

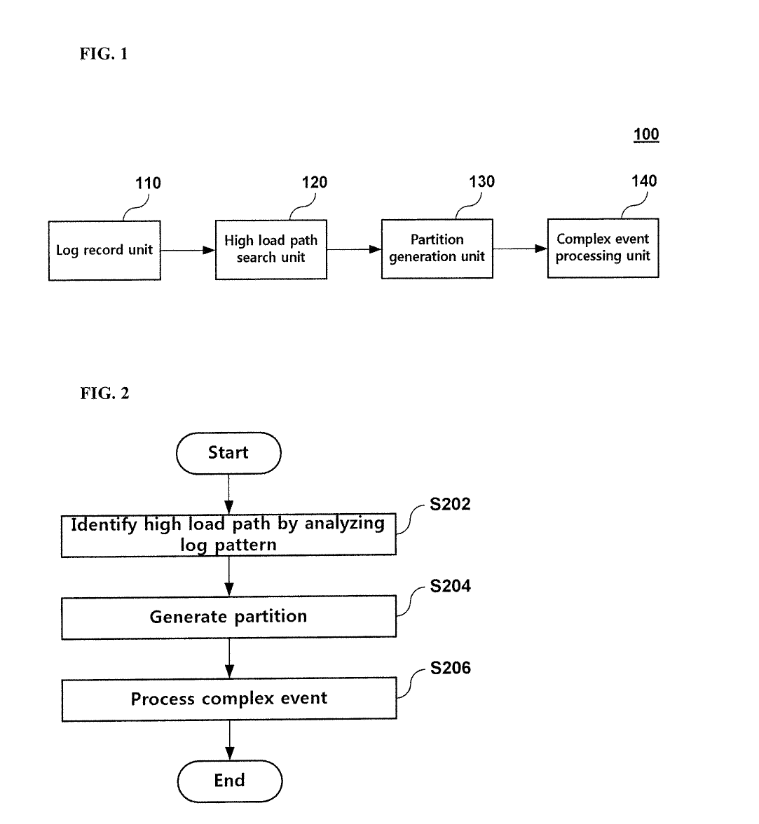

FIG. 1 is a diagram schematically illustrating an apparatus for processing a complex event based on a high load path in accordance with an embodiment of the present invention.

Referring to FIG. 1, the apparatus 100 for processing a complex event based on a high load path (hereinafter referred to as a “complex event processing apparatus”) includes a log record unit 110, a high load path search unit 120, a partition generation unit 130, and a complex event processing unit 140.

The log record unit 110 records the log of a message transfer path. In this case, the log record unit 110 records the log of the message transfer path in the form of a state transition diagram and differently sets a work load depending on the number of times that the message transfer path is repeated and the amount of network communication. For example, the log record unit 110 may set a high work load for a path that is frequently repeated.

The log record unit 110 functions to collect event data from various event sources using a proper method. That is, the log record unit 110 may be configured by taking into consideration options, such as a real-time server (event queue) transmission method using an Open Application Programming Interface (API) and a real-time server transmission method using Java Message Service (JMS) by taking into consideration a load of an event source and the easiness of development.

Furthermore, the log record unit 110 performs functions, such as an event validation check, an event format conversion, error processing, and the status monitoring of communication with an event source.

The high load path search unit 120 identifies a high load path by analyzing the log pattern of a message transfer path that is stored in the log record unit 110.

The high load path search unit 120 identifies a message transfer path that is repeated by a predetermined specific number or more, a message transfer path in which a work load exceeds a predetermined specific threshold, and a message transfer path that requires the execution time of a predetermined specific time or more as a high load path by analyzing the log pattern of each message transfer path. That is, the high load path search unit 120 searches for a failure section in which a cost for the processing of a complex event is high, such as that a processing path is frequently repeated or that a lot of time is taken to execute a processing path, as a high load path.

In this case, the high load path search unit 120 may search for a high load path by analyzing a log pattern based on a cycle set by a user, such as one day, one week, or one month. In some embodiments, the high load path search unit 120 may analyze only a log pattern up to a specific time in response to a forced command from a user irrespective of a period.

The partition generation unit 130 generates a partition based on a high load path retrieved by the high load path search unit 120.

That is, the partition generation unit 130 generates a partition by dividing a high load path by the number of workers.

In the case of a message transfer path other than a high load path, the partition generation unit 130 calculates the number of edges and allocates the edges to the most connected partition. The edge means that communication between nodes is generated. If an edge is allocated to the most connected partition, the amount of communication between partitions that are located in physically different positions can be reduced.

In the case of a message transfer path other than a high load path, the partition generation unit 130 divides a message transfer path by the number of workers and generates a partition so that the amount of work to be done may be equally distributed. In this case, the amount of work to be done is distributed by taking into consideration edges connected to a partition. To this end, the partition generation unit 130 allocates candidate nodes, connected to each partition, to a corresponding partition by an average number and sequentially allocates candidate nodes, not allocated after allocation is performed on all the partitions, to each partition irrespective of an edge.

The complex event processing unit 140 processes a complex event based on a partition generated by the partition generation unit 130.

The complex event processing unit 140 processes an event based on contents in which each of nodes allocated to each partition has been defined and generates an action plan. That is, the complex event processing unit 140 extracts data from a queue, converts the data in an event processing form, processes simple or complex events, determines a rule, and performs an action plan generation function based on a result of the determination.

Thereafter, the complex event processing unit 140 functions to execute a generated action plan based on contents that a defined action plan has been processed. The complex event processing unit 140 performs a function for automatically or manually executing an action plan and monitoring the current state of execution, a function for managing an action plan, and a function for mapping the action plan to a business event.

The complex event processing unit 140 may a variety of types of queues and processors for event processing. Each queue and each processor perform all the works in memory. Accordingly, there are advantages in that a load of a complex event processing system server can be minimized and data consistency can be maintained.

The complex event processing unit 140 functions to make collected data a business event and to process the business event, and it may perform general-purpose processing on the event attributes of various types. Data extracted from an event source is used to perform event determination and actions through various processors and queue works.

If data necessary to generate an event is not satisfied, a state proceeds to an awaiting event state. If such data is satisfied, a subsequent work may be performed.

An action in a connection event is to transfer the generation of an event to a processor queue.

In an embodiment, all the types of events that may define a total event, a stream event, a reference event, a connection event, and an awaiting event may be implemented by a system through a complex event processing system in addition to the processing of a simple event that may be performed through a rule engine.

That is, the complex event processing unit 140 in accordance with an embodiment of the present invention may process a complex event, that is, a combination of a variety of types of a plurality of events, such as a complex event including a plurality of simple events, a complex event including a simple event and a reference event, a complex event including a simple event and a stream event, and a complex event including a simple event and a connection event.

Each of the log record unit 110, the high load path search unit 120, the partition generation unit 130, and the complex event processing unit 140 may be implemented by a processor required to execute a program on a computing apparatus. As described above, the log record unit 110, the high load path search unit 120, the partition generation unit 130, and the complex event processing unit 140 may be implemented using respectively and physically independent elements or may be implemented in such a way as to be functionally separated within a single processor.

Such elements that may be included in the complex event processing apparatus 100 may be implemented using hardware, software, or a combination of them, or two or more of the elements may be implemented by a single piece of hardware or software.

The complex event processing apparatus 100 may communicate with other electronic devices in accordance with a variety of types of communication standards, and it may be implemented through an electronic device capable of performing various data processing operations. For example, the complex event processing apparatus 100 may be implemented in the form of a server apparatus or may be implemented in the form of various electronic devices in addition to such a server apparatus. Furthermore, the complex event processing apparatus 100 may be implemented in the form of a single electronic device or may be implemented in a form in which two or more electronic devices are combined.

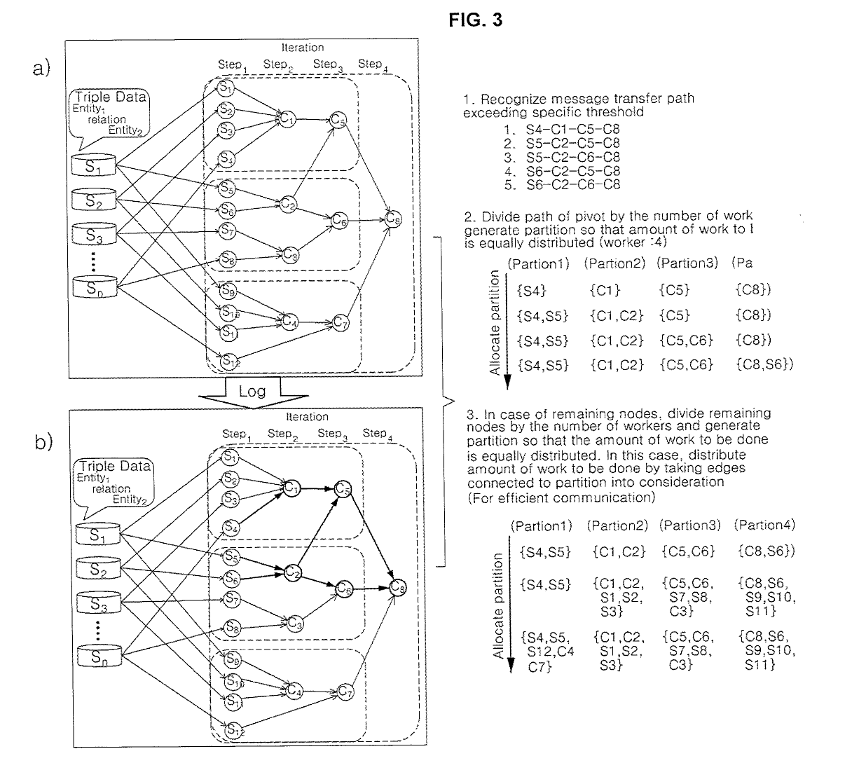

FIG. 2 is a diagram illustrating a method for processing, by the complex event processing apparatus, a complex event in accordance with an embodiment of the present invention, and FIG. 3 is an exemplary diagram of screens for illustrating a method for generating a partition in accordance with an embodiment of the present invention.

Referring to FIG. 2, the complex event processing apparatus identifies a high load path by analyzing the log pattern of a message transfer path at step S202. In this case, the complex event processing apparatus may identify a message transfer path that is repeated by a predetermined specific number or more or that requires the execution time of a predetermined specific time or more as the high load path by analyzing a log pattern corresponding to a cycle set by a user.

The complex event processing apparatus generates a partition based on the identified high load path at step S204. In this case, in the case of a high load path, the complex event processing apparatus may divide the high load path by the number of workers and generate a partition. In the case of a message transfer path other than a high load path, the complex event processing apparatus may calculate the number of edges and allocate the edges to the most connected partition.

The complex event processing apparatus processes a complex event based on the generated partition at step S206.

A method of generating, by the complex event processing apparatus, a partition is described below with reference to FIG. 3. In this case, it is assumed that the number of workers is 4.

If a complex event having a state transition diagram, such as that of FIG. 3(a), is collected, the complex event processing apparatus converts the state transition diagram into a state transition diagram based on a high load path based on a log that is activated for a specific period, as illustrated in FIG. 3(b).

The complex event processing apparatus identifies “S4-C1-05-C8”, “S5-C2-05-C8”, “S5-C2-C6-C8”,“S6-C2-05-C8”, and “S6-C2-C6-C8” that pass through a predetermined specific threshold as a high load path through the state transition diagram, such as that of FIG. 3(b).

Thereafter, the complex event processing apparatus divides the high load path by 4, that is, the number of workers, and generates a partition so that the amount of work to be done is equally distributed as illustrated in FIG. 3(c). Thereafter, in the case of a message transfer path other than a high load path, the complex event processing apparatus allocates nodes to a partition as illustrated in FIG. 3(d).

The method for processing a complex event described so far in accordance with an embodiment of the present invention may be implemented in the form of a program, application, or system file for executing the method. The present invention may be implemented in the form of a computer-readable recording medium on which such a program has been recorded.

Such a method for processing a complex event may be written in a program form, and codes and code segments that fowl the program may be easily deduced by a programmer skilled in the art. Furthermore, a program regarding the method of processing a complex event may be stored in a readable medium readable by an electronic device and may be read and executed by an electronic device.

As described above, in accordance with the present invention, a distribution/parallelism in processing a complex event can be effectively performed by effectively distributing a work load based on a high load path.

Furthermore, a change in a work load in processing a complex event according to a change of time can be flexibly handled by dynamically updating a partitioning criterion.

As described above, those skilled in the art to which the present invention pertains will understand that the present invention may be implemented in various detailed forms without changing the technical spirit or indispensable characteristics of the present invention. It will be understood that the aforementioned embodiments are illustrative and not limitative from all aspects. The scope of the present invention is defined by the appended claims rather than the detailed description, and the present invention should be construed as covering all modifications or variations derived from the meaning and scope of the appended claims and their equivalents.

What is claimed is:

1. An apparatus for processing a complex event based on a high load path, the apparatus comprising:
a high load path search unit configured to identify a high load path by analyzing a log pattern of a message transfer path; and
a partition generation unit configured to generate a partition based on the identified high load path.

2. The apparatus of claim 1, further comprising a log record unit configured to record a log of the message transfer path, wherein the log record unit differently sets a work load depending on a work repetition number of the message transfer paths or an amount of network communication.

3. The apparatus of claim 1, wherein the high load path search unit identifies a message transfer path that is repeated by a predetermined specific number or more or that requires an execution time of a predetermined specific time or more as the high load path by analyzing the log pattern.

4. The apparatus of claim 1, wherein:
in a case of a high load path, the partition generation unit divides the high load path by the number of workers and generates a partition, and
in a case of a message transfer path other than a high load path, the partition generation unit calculates the number of edges and allocates the edges to the most connected partition.

5. The apparatus of claim 1, further comprising a complex event processing unit configured to process a complex event based on the partition generated by the partition generation unit.

6. A method for processing, by a complex event processing apparatus, a complex event based on a high load path, the method comprising:
identifying a high load path by analyzing a log pattern of a message transfer path; and
generating a partition based on the identified high load path.

7. The method of claim 6, further comprising recording a log of a message transfer path before identifying the high load path by analyzing the log pattern of the message transfer path.

8. The method of claim 6, wherein the high load path comprises a message transfer path that is repeated by a predetermined specific number or more or that requires an execution time of a predetermined specific time or more.

9. The method of claim 6, wherein generating the partition comprises:
dividing the high load path by the number of workers and generating a partition in a case of a high load path, and
calculating the number of edges and allocating the edges to the most connected partition in a case of a message transfer path other than a high load path.

10. The method of claim 6, further comprising processing a complex event based on the generated partition after generating the partition based on the identified high load path.

11. A computer-readable recording medium on which a program for executing a method for processing a complex event based on a high load path has been recorded, the method comprising:
identifying a high load path by analyzing a log pattern of a message transfer path when the program is executed by the complex event processing apparatus; and
generating a partition based on the identified high load path.
